(19) United States
(12) Patent Application Publication
(10) Pub. No.: US 2024/0195330 A1
(43) Pub. Date: Jun. 13, 2024

(54) A CYCLE POWER GENERATION DEVICE

(71) Applicant: Yi Huang, Maoming City, Guangdong (CN)

(72) Inventor: Yi Huang, Maoming City, Guangdong (CN)

(21) Appl. No.: 17/794,923

(22) PCT Filed: Jan. 20, 2022
(86) PCT No.: PCT/CN2022/072860

§ 371 Date: Jul. 22, 2022

(30) Foreign Application Priority Data
Jan. 6, 2022 (CN) 202210007791.5

(51) Int. Cl. H02N 11/00

(52) U.S. Cl. CPC H02N 11/008; H02N 11/002; H02N 11/006

(57) ABSTRACT

The invention discloses a cycle power generation device, comprising a battery, a motor and a generator. The battery is a rechargeable battery and is connected with the motor through a power transmission line. The motor drives the generator to rotate, and the electricity returns to the motor through the power transmission line in series after producing electricity, thereby achieving the cycle power generation by driving the motor. The battery is provided for starting the motor at the initial stage, and the motor is driven by the electricity from the generator instead of the battery, after driving the generator to produce electricity by rotating the motor. The electricity produced by the generator is linearly transmitted to the motor, and the motor drives the generator to generate electricity, which is the cycle power generation.

### 1. TECHNICAL FIELD

The invention relates to the field of energy conversion, in particular to a cycle power generation device.

### 2. BACKGROUND

The cycle generator can be used for supplying the various load with the electric power, and the motor drives the generator to produce electricity, resulting in low energy consumption; the environment-friendly motor is merely provided for energy supply. The device provided by the invention rotates the motor to drive the generator to produce electricity, and the battery is merely provided for starting the motor.

To solve the above problem, a cycle power generation device becomes a critical issue in society.

### 3. SUMMARY OF THE INVENTION

The technical problem to be solved by the invention is to provide a cycle power generation device comprising the generator, the motor and the battery. The battery is provided with the positive terminal and the negative terminal, wherein the generator is electrically connected with the buck converter; the battery is electrically connected with the motor through the positive terminal and the negative terminal; the motor is electrically connected through the output wire The motor is electrically connected to the generator through the output wire.

The invention discloses a cycle power generation device, comprising the lead-acid battery, the motor and the generator. The battery drives the motor and the motor drives the generator to rotate and the electricity returns to the motor through the power transmission line in series after producing electricity. The motor is driven by the electricity from the generator instead of the battery.

Further, the generator is electrically connected to the buck converter through the output wire.

Further, the output wire of the buck converter is provided to connect on the positive terminal and negative terminal; the positive terminal and negative terminal are provided with the input wire and output wire; the input wire is connected to the motor, and the buck converter is provided between the generator and battery. The positive and negative terminals are provided separately, and the resistor is provided for voltage reduction.

Further, the battery is a rechargeable battery and the device is provided with merely one battery. The battery can output electricity and be charged simultaneously. The lead-acid batteries or the lithium battery is provided for the invention.

Further, the generator, the motor, the battery and the buck converter are connected in sequence to form a circuit.

Preferably, the battery is provided for starting the motor at the initial stage, and the motor drives the generator to produce electricity, which returns to the motor with the circuit transmission line, to rotate the motor and then to drive the generator, achieving the cycle power generation.

Preferably, the lead-acid battery drives the electric motor to rotate and then drives the generator to rotate to produce electricity.

Preferably, the lead-acid battery drives the motor to rotate, wherein the motor includes the alternating-current motor, direct-current motor and permanent-magnet motor; the varieties of battery include the lead-acid battery, zinc-iron battery, boron battery and all other rechargeable batteries.

Preferably, the electricity produced by the generator returns to transmit to the circuit transmission line of the motor in series.

Preferably, the circuit transmission line is provided between the generator and the motor, and is the series connection to the voltage dependent resistor on the positive wire for voltage transformation as well as the voltage dependent resistor on the negative wire for voltage transformation, to input into the battery, including buck converter for voltage reduction.

Preferably, the alternating current produced by the generator is directly returned to transmit to the motor.

Preferably, the electricity produced by the generator is returned to transmit to the motor after transformed with voltage dependent resistor.

Preferably, the No. 1 battery drives the motor to drive the generator; the electricity produced by the generator drives the No. 2 motor then to drive the generator; and the electricity produced by the generator drives the No. 3 motor, to drive the generator to rotate to produce the electricity.

The advantages of the invention compared with the prior art are as follows: the invention provides lead-acid batteries to drive the motor to rotate, and the motor drives the generator to rotate and produce the electricity; wherein the electricity returns to transmit to the motor in series, achieving the purpose of cycle power generation; the cycle transmission line between the motor and the generator is connected to the battery in series with voltage dependent resistor, to output electricity and be charged simultaneously, realizing the conversion of the excess power of the motor through the generator and finally achieving the recycling.

### 4. BRIEF DESCRIPTION OF ACCOMPANY DRAWINGS

FIG. 1 is a schematic diagram of the system structure of a cycle power generation device provided by the invention;

FIG. 2 is a schematic diagram of the structure of the battery provided by the invention.

In the figures:
1. the generator; 2. the motor; 3. the battery; 4. The buck converter.

### 5. SPECIFIC EMBODIMENT OF THE INVENTION

A further description of the invention is given below in combination with the attached drawings.

The specific implementation of the cycle power generation device provided by the invention, comprises the generator 1, the motor 2 and the battery 3 provided with the positive terminal and the negative terminal, wherein the generator 2 is electrically connected with a buck converter 4, the battery 3 is electrically connected with the motor 2 through the positive terminal and the negative terminal, the motor 2 is electrically connected through the output wire The motor 2 is electrically connected to the generator 1 through the output wire.

The generator 1 is electrically connected to the buck converter 4 through the output wire. The output wire of the buck converter 4 is used to connect on the positive terminal and the negative terminal. The battery 3 is a rechargeable battery. The generator 1, the motor 2, the battery 3 and the buck converter 4 are connected in sequence to form a circuit.

The cycle power generation device comprises the lead-acid battery, the motor and the generator. The battery drives the motor and the motor drives the generator to rotate and the generator produces electricity.

The battery is a rechargeable battery for recycling use and the battery can output electricity and be charged simultaneously. The battery varieties include the lead-acid battery, zinc-iron battery, boron battery and all other rechargeable batteries.

The battery is provided with the voltage dependent resistor for voltage transformation and electricity transmission.

The battery is provided for outputting electricity and inputting electricity.

The power transmission line is the series connection to the voltage dependent resistor on the positive wire for voltage transformation as well as the voltage dependent resistor on the negative wire for voltage transformation, to input into the battery or buck converter for voltage reduction.

The alternating current produced by the generator is directly transmitted to the motor.

The specific implementation steps of the invention are as follows:

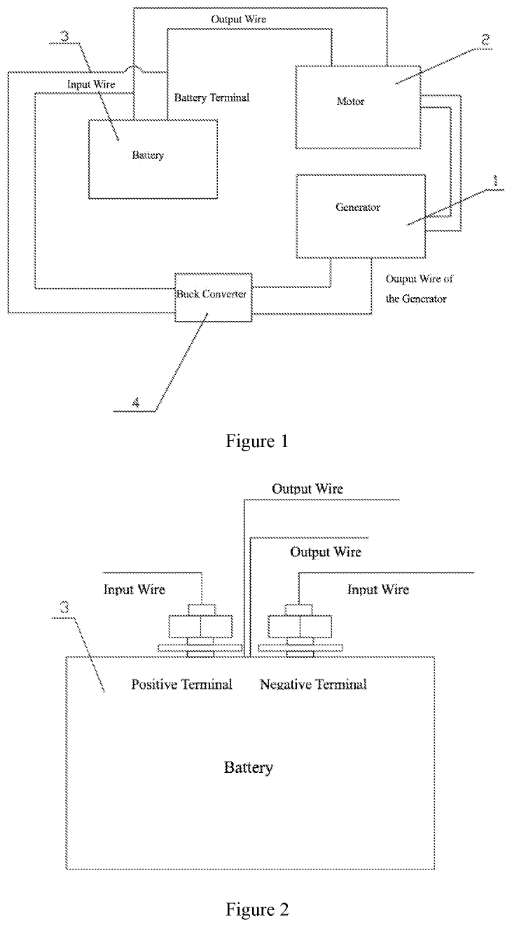

With reference to FIG. 1 and FIG. 2, the cycle power generation device comprises the generator 1, the motor 2 and the battery 3 provided with a positive terminal and a negative terminal; the generator 2 is electrically connected with a buck converter 4, the battery 3 is electrically connected with the motor 2 through the positive terminal and the negative terminal, the motor 2 is electrically connected through the output wire. The motor 2 is electrically connected to the generator 1 through the output wire. The battery 3 drives the motor 2 to operate, and the motor 2 drives the generator 1 to operate; the motor is connected to the two input wires of the battery 3 through the output wire of the generator.

The battery 3 is rechargeable batteries that are available for recyclable use. The battery level can be recovered by the form of charging when the battery power drops to a certain extent; the varieties of battery include but are not limited to lead-acid batteries, lithium batteries, and so on.

The positive terminal of the battery is provided with the input wire and output wire.

The iron spacer is provided between the input wire and the output wire, and the input wire is provided above the output wire.

The input wire is provided for driving the motor, and the resistor for voltage reduction is provided on the positive wire between the generator and the battery; the negative wire is provided with the resistor for voltage reduction, and the buck converter of the positive and negative wire is separate.

The working principle of the invention is as follows: the lead-acid battery drives the motor to rotate, to drive the generator; the generator rotates and produces the electricity; the electricity produced by the generator transmits to the motor through the power transmission line in series; the electricity produced by the generator transmits to the motor through the power transmission line, to transmit between the motors and to connect the battery in series for outputting and inputting electricity.

The circuit transmission line is the series connection to the voltage dependent resistor on the positive wire for voltage transformation as well as the voltage dependent resistor on the negative wire for voltage transformation, to charge into the battery.

The invention and the embodiments thereof are described hereinabove, and this description is not restrictive. What is shown in the drawings is only one of the embodiments of the invention, and the actual structure is not limited thereto. In summary, structural methods and embodiments similar to the technical solution without departing from the inventive purpose of the invention made by inspired ordinary technicians in the art without creative efforts shall all fall within the protection scope of the invention.

1. A cycle power generation device comprising a generator, a motor and a battery provided with a positive terminal and a negative terminal, wherein the generator is electrically connected with a buck converter, the battery is electrically connected with the motor through the positive terminal and the negative terminal, the motor is electrically connected through the output wire; the motor is electrically connected to the generator through the output wire.

2. The cycle power generation device according to claim 1, wherein the generator is electrically connected to the buck converter through the output wire.

3. The cycle power generation device according to claim 1, wherein the output wire of the buck converter is used to connect to the positive terminal and the negative terminal.

4. The cycle power generation device according to claim 1, wherein the battery is a rechargeable battery.

5. The cycle power generation device according to claim 1, wherein the generator, the motor, the battery and the buck converter are connected in sequence to form a circuit.
